(19) United States
(12) Patent Application Publication
(10) Pub. No.: US 2015/0156987 A1
(43) Pub. Date: Jun. 11, 2015

(54) ANIMAL WOUND PROTECTOR

(71) Applicants: Wanda E. Baynes, Indianapolis, IN (US); John L. Baynes, II, Indianapolis, IN (US)

(72) Inventors: Wanda E. Baynes, Indianapolis, IN (US); John L. Baynes, II, Indianapolis, IN (US)

(21) Appl. No.: 14/103,357

(22) Filed: Dec. 11, 2013

(51) Int. Cl. A01K 13/00

(52) U.S. Cl. CPC A01K 13/006

(57) ABSTRACT

A building security system includes a security sensor for sensing a security breach associated with a building. An electronic location-detecting device senses fixed geographic coordinates of the building. An electronic processor responds to a security breach sensed by the security sensor by transmitting an alarm signal to a central monitoring station. The alarm signal includes the fixed geographic coordinates of the building sensed by the location-detecting device.

### BACKGROUND

### Summary

The invention is directed to a healing shield which protects animal wounds and surgical sites, such as on dogs and cats. The healing shield may eliminate the need for E-collars. The healing shield may prevent the animal from biting, licking and scratching wounds, surgical sites, and tails, which may be either long or cropped. The shield may be made of a durable solid and aerated plastic material, Velcro, leather straps, and o-rings which may have cushioning on both ends of the shields to deter chafing. The shield straps may be adjustable to fit all sizes of dogs and cats.

The tail and leg healing shields may come in all colors and may be designed to have disposable bandages that fit the wounded area to promote healing and keep the wound dry. The shields can be worn with or without bandages at the discretion of the owner of the animal. The bandages may come in different widths and lengths and may have perforated edges to allow easy closure of bandage ends with high absorbency materials to keep moisture from the wound. The bandages may come in a roll that may be cut to a desired size.

In one aspect, the invention includes an animal wound protection apparatus including a cylindrical shell having a cylindrical channel receiving and protecting a tail of the animal. An annular element is placed around a mid-section of the animal. A first connecting element interconnects the annular element and the cylindrical shell. The first connecting element is placed along a top side of the animal. A second connecting element interconnects the annular element and the cylindrical shell. The second connecting element is placed along a bottom side of the animal.

In another aspect, the invention includes an animal wound protection apparatus including a cylindrical shell having a cylindrical channel receiving and protecting one of a right front leg and a left front leg of the animal. An annular element is placed around an other of the right front leg and the left front leg of the animal. A connecting element interconnects the annular element and the cylindrical shell. The second connecting element is placed across the shoulders of the animal.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a side view of one embodiment of an animal wound protector system of the invention on a dog;

FIG. 2 is a rear view of the system of FIG. 1 on a dog;

FIG. 3 is a rear view of another embodiment of a rear leg apparatus of the invention;

FIG. 4 is a bottom view of another embodiment of a tail protector of the invention;

FIG. 5 is a plan view of the rear leg apparatus of FIG. 1 laid out flat;

FIG. 6 is a plan view of one embodiment of a bandage suitable for use with an animal wound protector system of the invention;

FIG. 7 is a perspective view of another embodiment of bandage applied to a dog's tail;

FIG. 8 is a side perspective view of another embodiment of a tail protector of the present invention;

FIG. 9 is a side perspective view of yet another embodiment of a tail protector of the present invention;

FIG. 10 is a plan view of another embodiment of a bandage suitable for use with an animal wound protector system of the invention;

FIG. 11a is a side perspective view of still another embodiment of a tail protector of the present invention;

FIG. 11b is a lengthwise view of the tail protector of FIG. 11a along line 11b-11b; and

FIG. 12 is a side perspective view of a further embodiment of two tail protectors of the present invention aligned end to end.

Corresponding reference characters indicate corresponding parts throughout the several views. Although the drawings represent embodiments of the invention, the drawings are not necessarily to scale and certain features may be exaggerated in order to better illustrate and explain the invention. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

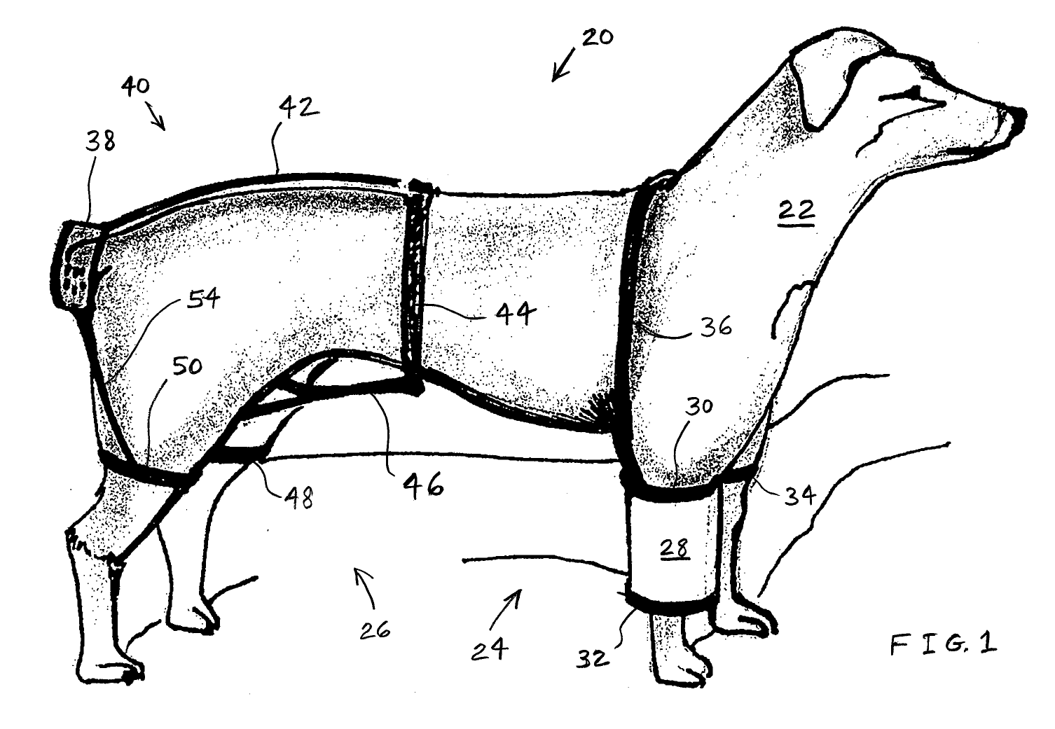

Referring now to the drawings, and particularly to FIG. 1, there is shown one embodiment of an animal wound protector system 20 of the invention for an animal 22 such as a dog. System 20 includes a front leg apparatus 24 and a rear leg apparatus 26. Front leg apparatus 24 includes on the dog's right leg a plastic, cylindrical leg protector 28 having cushioning O-rings 30, 32 at opposite ends thereof, and on the dog's left leg a cushioning O-ring 34. A strap 36 of adjustable length is attached both to O-ring 34 and to the right leg assembly including protector 28 and O-rings 30, 32. Strap 36 may include Velcro for adjusting the length of strap 36. Strap 36 may extend over the shoulders of the animal.

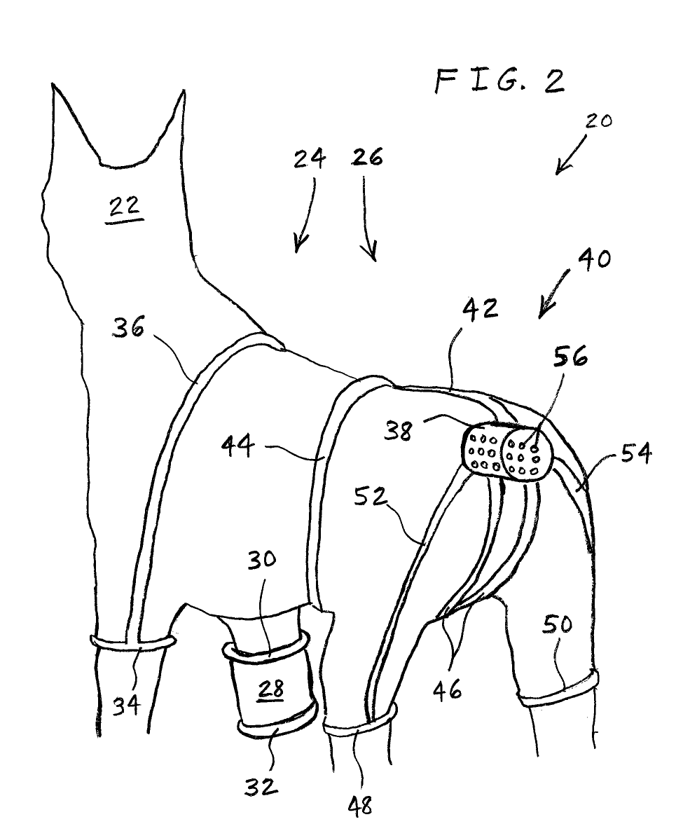

Rear leg apparatus 26 includes on the dog's tail a cylindrical tail protector or shield holder 38 held in place by a harness 40. Harness 40 includes a strap or adjustable rod 42 extending along the dog's spine. Rod 42 may be made of plastic and Velcro. Harness 40 further includes a waist strap 44 attached to strap/rod 42 as well as to Y-shaped belly harness strap 46. Waist strap 44 may be an elastic stabilizing strap with a female snapper for adjustment, and the middle comes around the belly or mid-section to meet the top to the back. As best shown in FIG. 2, the opposite ends of Y-shaped strap 46 may be attached to tail protector 38. Two cushioning leg O-rings 48, 50 are on the dog's left and right legs, respectively, and may be formed of plastic with a foam cloth cover made of rayon or other smooth material to prevent hair loss. A left leg strap 52 is attached to both tail protector 38 and O-ring 48, and a right leg strap 54 is attached to both tail protector 38 and O-ring 50. Tail protector 38 may include a pattern of throughholes 56 for aeration, i.e., to enable air to reach the site of the wound.

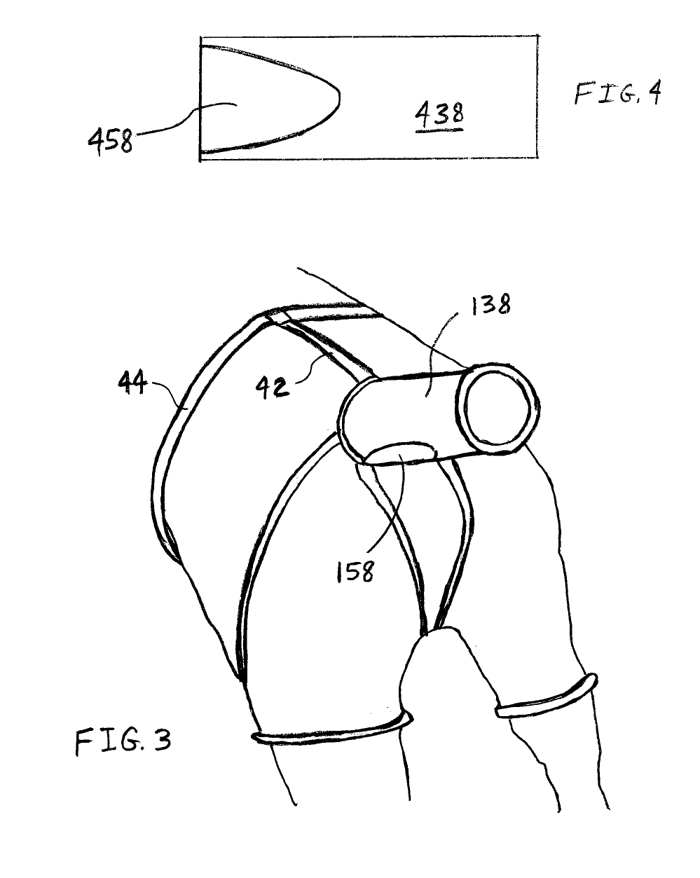

In another embodiment (FIG. 3), a tail protector 138 may include a large oval throughhole 158 at a lowest point of the cylindrical body in order to allow feces to fall therethrough. In another embodiment (FIG. 4), a tail protector 438 may include a throughhole 458 having the shape of half of an oval, with the widest portion of throughhole 458 being at the longitudinal end of tail protector 438. Aeration holes may be eliminated in these embodiments due to the air flow provided by the throughholes.

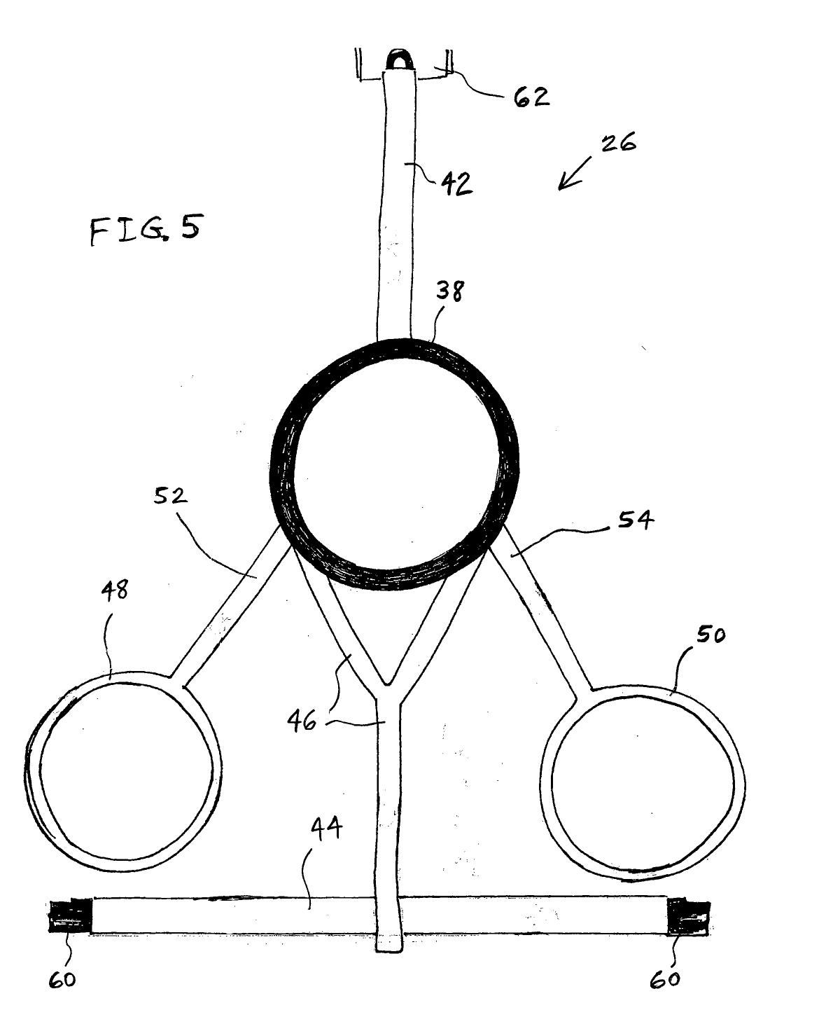

Rear leg apparatus 26 is shown being laid out flat in FIG. 5. Both straps 42, 44 may have mating snap connectors, with male connectors 60 being on strap 44 and female connectors 62 being on back harness strap 42. Female connectors 62 may be in the form of a double edge detailed connection with female snap holders and a center for adjustment. Both strap 42, 46 have a flexible rubber plastic insert glued or melted in place, and which can be cut to fit. All of the straps in rear leg apparatus 26 may come in a sliding adjustable material form. All straps may be made of leather, spandex, or nylon material.

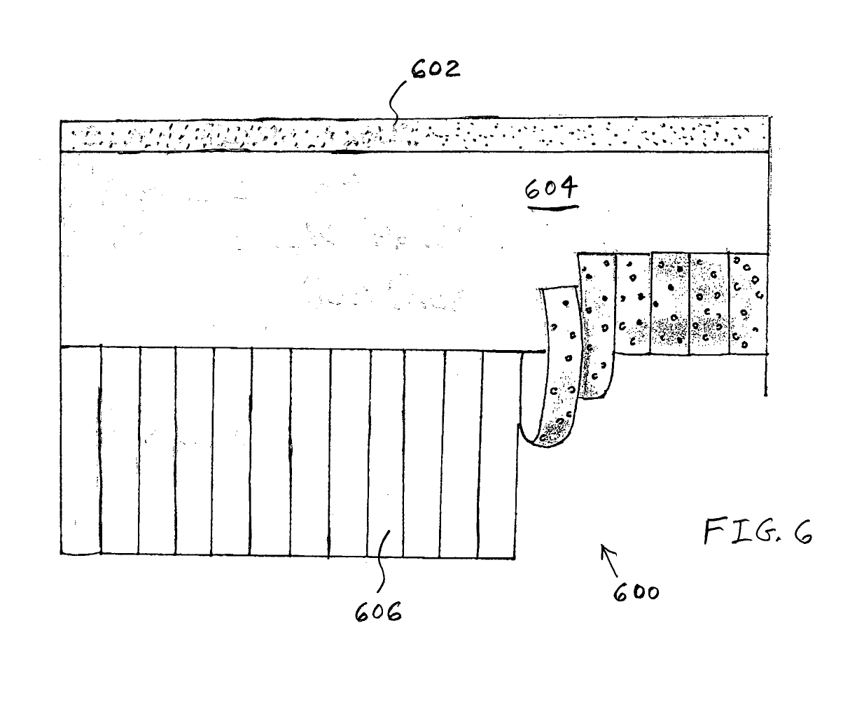

FIG. 6 is a plan view of one embodiment of a bandage 600 suitable for use with an animal wound protector system of the invention. Bandage 600 includes a first outer section 602 formed of glue disposed on peel paper. A middle section 604 is in the form of an absorbent non-stick pad surface. A second outer section 606 is formed of perforated peel paper. Bandage 600 may come in rolls of 25 feet, 50 feet, or longer. The perforation ends enable bandage 600 to be closed on the tail. The bandage may be left open on leg wounds. The perforations and scoring of the tape may enable the peel paper to be easily torn.

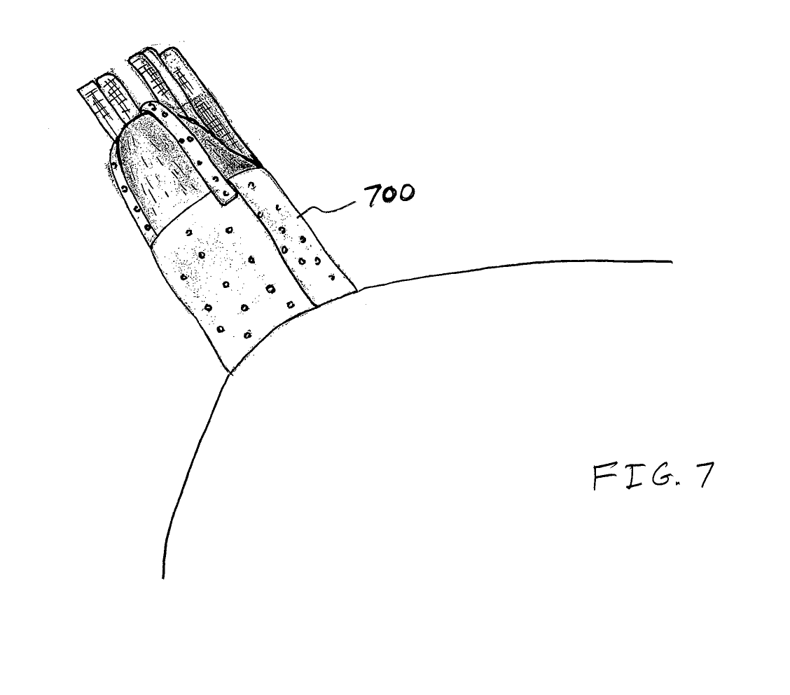

FIG. 7 is a perspective view of another embodiment of a bandage 700 applied to a dog's tail. Bandage 700 is perforated to enable air to reach the dog's tail. The perforated peel paper may be draped over the end of the dog's tail as shown and secured by the glue to the middle section of the bandage on the opposite side of the tail.

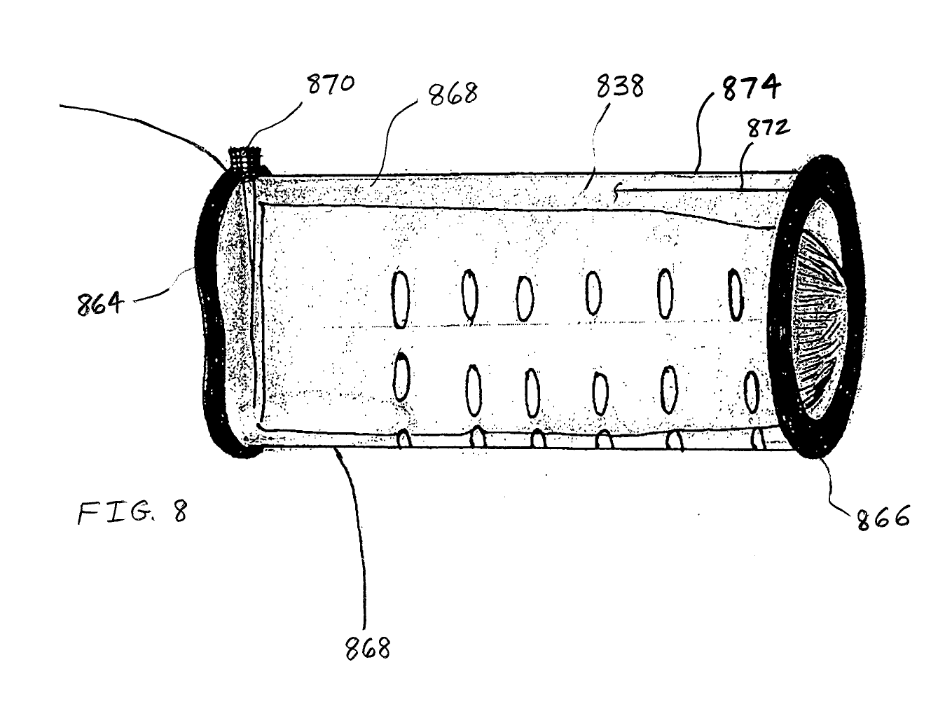

FIG. 8 is a side perspective view of another embodiment of an aerated tail protector 838 of the present invention including an adhesive lip 864, a protective end cap 866, and a double cylindrical wall 868. An air injector stem 870 or harness is in fluid communication with a cylindrical space between the two walls. Air may be injected through stem 870 into the space between the two walls to thereby cause the inner wall to snugly engage the animal's tail. An inner wall 872 is only partially and schematically shown in FIG. 8 in opposition to outer wall 874.

FIG. 9 is a side perspective view of another embodiment of an aerated tail protector 938 of the present invention including an adhesive lip 964, and a protective end cap 966.

FIG. 10 is a plan view of another embodiment of a bandage 1000 suitable for use with an animal wound protector system of the invention. Bandage 1000 includes an absorbent non-stick pad surface 1004 and perforated peel paper 1006. Bandage 1000 may come in rolls of 25 feet, 50 feet, or longer. The ends 1008 enable bandage 1000 to be closed on the tail. The bandage may be left open on leg wounds.

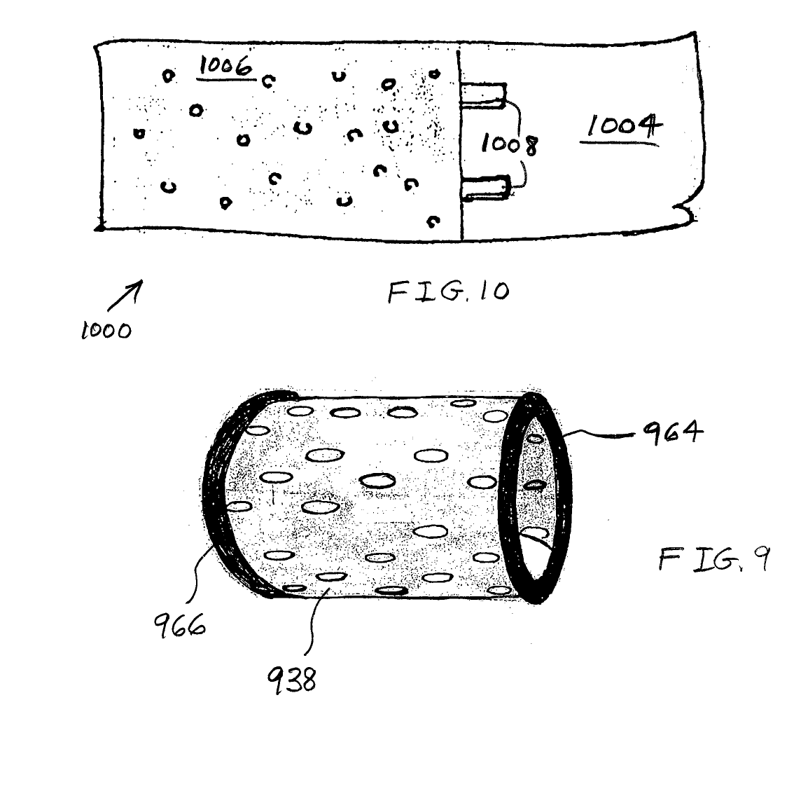

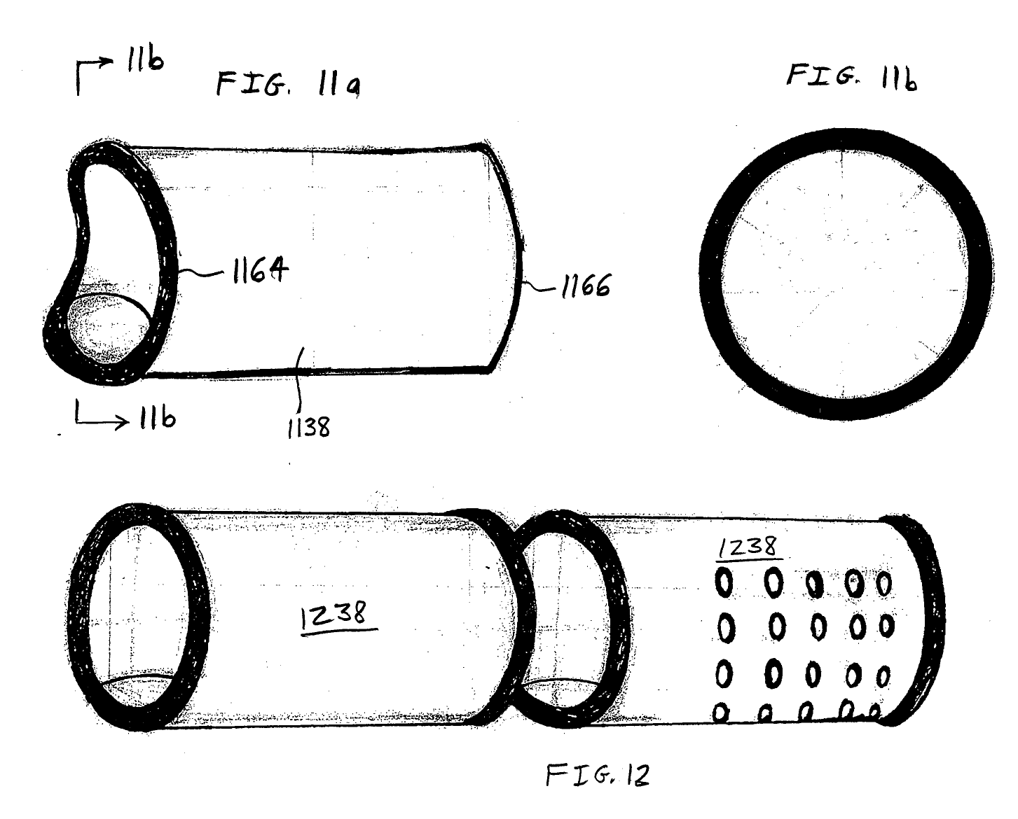

FIG. 11a is a side perspective view of another embodiment of an aerated tail protector 1138 of the present invention including a contoured adhesive lip 1164, and a protective end cap 1166. Contoured adhesive lip 1164 may be shaped to conform to the typical shape of a dog's body around the tail. As shown in FIG. 11b, contoured adhesive lip 1164 may have a circular shape as viewed along the length of protector 1138.

As shown in FIG. 12, two tail protectors 1238 may be aligned end to end for placement on a dog's tail that is longer.

While this invention has been described as having an exemplary design, the invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An animal wound protection apparatus, comprising:
a cylindrical shell having a cylindrical channel configured to receive and protect a tail of the animal;
an annular element configured to be placed around a mid-section of the animal;
a first connecting element interconnecting the annular element and the cylindrical shell, the first connecting element being configured to be placed along a top side of the animal; and
a second connecting element interconnecting the annular element and the cylindrical shell, the second connecting element being configured to be placed along a bottom side of the animal.

2. The apparatus of claim 1 wherein the annular element comprises a first annular element, the apparatus further comprising:
a second annular element configured to be placed around a left leg of the animal;
a third annular element configured to be placed around a right leg of the animal;
a third connecting element interconnecting the second annular element and the cylindrical shell; and
a fourth connecting element interconnecting the third annular element and the cylindrical shell.

3. The apparatus of claim 2, wherein the second annular element and/or the third connecting element comprises an O-ring.

4. The apparatus of claim 1 wherein the cylindrical shell is perforated.

5. The apparatus of claim 1 wherein an end of the shell is configured to engage the animal's body, a wall of the cylindrical shell including a throughhole at the end of the shell, the throughhole having a width of at least two inches and thereby being sized to allow feces from the animal to pass therethrough.

6. The apparatus of claim 1 wherein an end of the shell that is configured to engage the dog's body is contoured to conform to the shape of a typical dog's body adjacent to the tail.

7. The apparatus of claim 1, further comprising perforated tape configured to be wrapped around the animal's tail.

8. The apparatus of claim 1, wherein the cylindrical shell is double walled and the two walls define a space therebetween, the shell including an air injector stem in fluid communication with the space between the two walls, an inner one of the two walls being configured to snugly engage the animal's tail in response to air being injected into the space between the two walls.

9. An animal wound protection apparatus, comprising:
a cylindrical shell having a cylindrical channel configured to receive and protect one of a right front leg and a left front leg of the animal;
an annular element configured to be placed around an other of the right front leg and the left front leg of the animal; and
a connecting element interconnecting the annular element and the cylindrical shell, the second connecting element being configured to be placed across the shoulders of the animal.

10. The apparatus of claim 9, wherein the annular element comprises an O-ring.

11. The apparatus of claim 9, wherein the cylindrical shell is perforated.

12. The apparatus of claim 9, wherein the cylindrical shell is double walled and the two walls define a space therebetween, the shell including an air injector stem in fluid communication with the space between the two walls, an inner one of the two walls being configured to snugly engage the animal's tail in response to air being injected into the space between the two walls.
